(19) United States
(12) Patent Application Publication
(10) Pub. No.: US 2022/0048319 A1
(43) Pub. Date: Feb. 17, 2022

(54) WHEEL BEARING ASSEMBLY AND INSTALLATION METHOD

(71) Applicant: AKTIEBOLAGET SKF, GOTEBORG (SE)

(72) Inventors: Ludwig Edelmann, Sulzthal (DE); Dominic Namyslo, Gädheim (DE); Matthias Schuler, Stadtlauringen (DE); Johannes Klaus Zang, Schweinfurt (DE)

(21) Appl. No.: 17/379,206

(22) Filed: Jul. 19, 2021

(30) Foreign Application Priority Data
Aug. 17, 2020 (DE) 102020210438.7

(51) Int. Cl. B60B 27/00

(52) U.S. Cl. CPC B60B 27/0073; B60B 27/001; B60B 2380/14; B60B 2900/5118; B60B 2310/316; B60B 27/0078

(57) ABSTRACT

A wheel bearing assembly includes at least one hub having an axial outboard end, a first bearing installed in the hub and having an outer ring and an inner ring, and at least one seal element that seals against a radially inner surface of the first bearing inner ring in a liquid-tight manner. The first bearing is the outboard-most bearing of the wheel bearing assembly.

### CROSS-REFERENCE

This application claims priority to German patent application no. 10 2020 210 438.7 filed on Aug. 17, 2020, the contents of which are fully incorporated herein by reference.

### TECHNOLOGICAL FIELD

The disclosure is directed to a wheel bearing assembly including an improved seal.

### BACKGROUND

According to FIG. 1, a wheel bearing assembly is known that includes a first tapered roller bearing 10 and a second tapered roller bearing 12. An inner ring 14 of the first tapered roller bearing and an inner ring 16 of the second tapered roller bearing abut axially against each other and are attached to each other in an interference-fit manner by a ring 18. Both an outer ring 20 of the first tapered roller bearing and an outer ring 22 of the second tapered roller bearing are pressed into a hub (not depicted). An O-ring 24 abuts against a radially outer-lying surface of the inner ring 14 and against a radially outer-lying surface of the inner ring 16, and thereby seals an interior of the wheel bearing assembly against an entry of oil through end sides of the inner rings 14, 16, which end sides abut axially against each other. The inner rings 14, 16 are disposed on a pin (not depicted), and oil is located between the pin and the inner ring. The O-ring 24 is pressed radially inward against the inner ring 14, 16 by a plastic ring 26. Furthermore, a further O-ring 28 is disposed radially inward on an axial end of the inner ring 16, which further O-ring 28 prevents dirt from a spatial region 30, which is located axially adjacent to the tapered roller bearings, from penetrating between the pin and the inner rings. Furthermore, the O-ring 28 prevents oil from reaching into the spatial region 30, wherein inter alia a brake disc (not depicted) is disposed, and from which the oil could reach outward through a seal 32 to the interior spaces of the tapered roller bearings. Oil, which has already reached between the inner ring 16 and the outer ring 22, can also reach through the seal 32 into the spatial region 30.

### SUMMARY

An aspect of the disclosure is to provide a wheel bearing assembly of the above-described type having high operational reliability.

A wheel bearing assembly is disclosed that includes at least one hub and at least one first bearing inner ring, which, of all bearing inner rings of the wheel bearing assembly, has a shortest distance from an outboard-side axial end of the wheel bearing assembly. That is, the first bearing inner ring is the axially outermost or axially outboard-most inner ring of the wheel bearing assembly.

The wheel bearing assembly includes at least one seal element that seals against a radial inner surface of the first bearing inner ring in a liquid-tight manner. A high operational reliability can thereby be achieved. In particular, it can be achieved that the seal element can be preinstalled against the radial inner surface, and therefore its presence is controllable both during the preinstallation and during a final installation without additional expense, whereby a high operational reliability is achievable. In particular, oil can be reliably prevented from reaching a brake disc, where it could seriously impair brake function.

The first bearing inner ring preferably includes a groove on a radially inner-lying surface, by which groove the seal element is attached to the bearing inner ring. This makes the bearing ring simple to install on an axle pin and thus simple to preinstall on the axle pin.

The groove is advantageously axially spaced from a raceway of the first bearing inner ring, which raceway is configured for the rolling of rolling elements of the wheel bearing assembly. In this way a uniform transmission of bearing forces onto the axle pin is achieved.

Furthermore, the wheel bearing assembly includes an axle pin and a second bearing inner ring, and the wheel bearing assembly is free of seals that are disposed between the axle pin and the second bearing inner ring. In this way a cost-effective construction can be achieved.

The wheel bearing assembly is preferably free of seals that seal against a radial outer side of the first bearing inner ring between the first bearing inner ring and a second bearing inner ring of the wheel bearing assembly. Components can thereby be saved and a cost-effective design can be achieved.

The seal element is advantageously configured as an O-ring. In this way a constructively simple design can be achieved.

In addition, the wheel bearing assembly includes at least one seal unit sealing against oil, which seal unit is disposed on an axial-side end of the first bearing inner ring and is disposed on a radial outer surface of the first bearing inner ring. Oil can thereby be prevented from reaching a brake disc.

The seal element preferably seals between the first bearing inner ring and an axle pin in a liquid-tight manner. In this way it can be prevented that oil reaches between outer and inner rings of the bearing assembly and to a brake disc element.

Another aspect of the disclosure comprise a wheel bearing assembly that includes at least one hub having an axial outboard end and a first bearing installed in the hub. The first bearing has an outer ring and an inner ring, and at least one seal element that seals against a radially inner surface of the first bearing inner ring in a liquid-tight manner. The first bearing is the outboard-most bearing of the wheel bearing assembly.

Furthermore, a wheel bearing inner ring is disclosed, in particular for a wheel bearing assembly as described above, including an O-ring, wherein the wheel bearing inner ring includes a groove on a radially inner surface, in which groove the O-ring is at least partially disposed. A high operational reliability can thereby be achieved.

In addition, a motor vehicle is disclosed, in particular a truck, including a wheel bearing assembly as described above, wherein a wheel supported by the wheel bearing assembly is drivable by an oil-lubricated drive axle of the motor vehicle.

Furthermore, an installation method is disclosed for installing a wheel bearing assembly, in particular a wheel bearing assembly as described above, in which a seal element is attached to a radially inner side of a first bearing inner ring, and in which the first bearing inner ring is subsequently attached in the hub to a seal element, so that in a completely installed state of the wheel bearing assembly the first bearing inner ring is the bearing inner ring that, in comparison to all other bearing inner rings of the wheel bearing assembly, has the shortest distance to an outboard-side axial end of the wheel bearing assembly. A high operational reliability can thereby be achieved.

Further advantages arise from the following description of the drawings. An exemplary embodiment of the invention is depicted in the drawings. The drawings, the description, and the claims contain numerous features in combination. The person skilled in the art will also advantageously consider the features individually and combine them into further meaningful combinations.

### BRIEF DESCRIPTION OF THE DRAWINGS

FIG. 1 is an axial section through a conventional wheel bearing assembly.

FIG. 2 is a partial axial section through a wheel bearing assembly according to an embodiment of the present disclosure.

### DETAILED DESCRIPTION

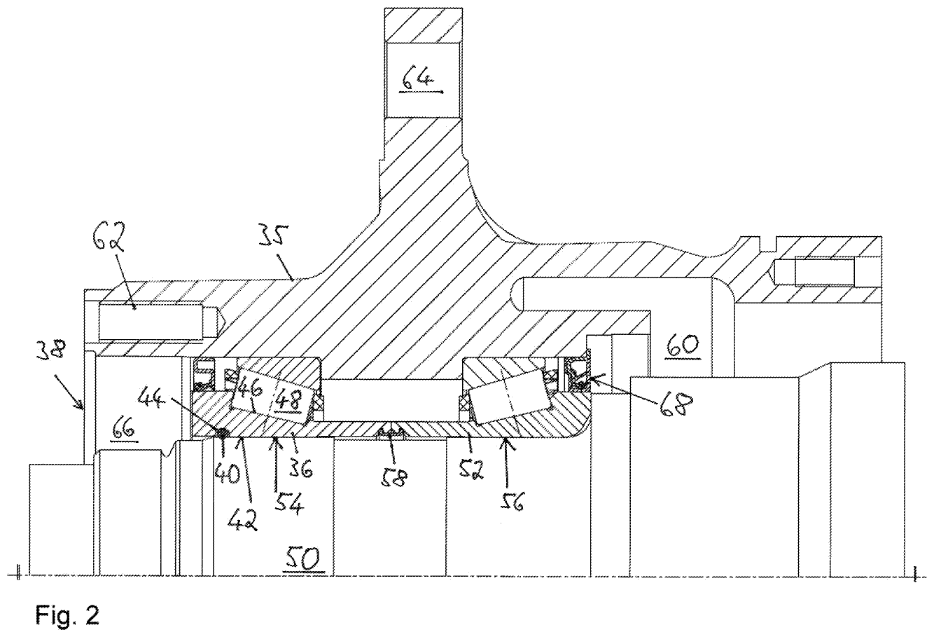

FIG. 2 shows an inventive wheel bearing assembly including a first tapered roller bearing 54 and a second tapered roller bearing 56, which are pressed in from different sides into a hub 35 of the wheel bearing assembly. A bearing inner ring 36 of the tapered roller bearing 54 and a bearing inner ring 52 of the tapered roller bearing 56 have end sides that abut against each other. The bearing inner rings 36, 52 are attached to each other in an interference-fit manner by a ring 58 of the wheel bearing assembly. The bearing inner ring 36 has a shorter distance from an axial outboard end 38 of the wheel bearing assembly than the bearing inner ring 52. Furthermore, the bearing inner rings 36, 52 are the only bearing inner rings of the wheel bearing assembly. In a state in which the wheel bearing assembly is part of a motor vehicle, the axial outboard end 38 is that axial end of the wheel bearing assembly that is facing away from a center of gravity and/or a longitudinal centerline of the motor vehicle. The motor vehicle can be a truck.

On a radial inner surface 42 of the first bearing inner ring, the wheel bearing assembly includes a seal element 40 that seals against the inner surface 42 in a liquid-tight manner. For this purpose the first bearing inner ring 36 includes a groove 44 on the radial inner surface 42, in which groove 44 the seal element 40 is disposed, and by which groove 44 the seal element is attached to the bearing inner ring 36. The tapered roller bearings 54, 56 are disposed on an axle pin 50 of the wheel bearing assembly, and the radial inner surface 42 abuts against the axle pin 50. The groove 44 and the seal element 40 extend completely around the axle pin 50 in the circumferential direction. In addition, the seal element 40 continuously abuts in the circumferential direction over 360° against the axle pin 50 and a base of the groove 44 so that the seal element seals between the bearing inner ring 36 and the axle pin 50 in a liquid-tight manner, and in particular with respect to oil. The seal element 40 is configured as an O-ring.

The wheel bearing assembly is free of seals that are disposed between the axle pin 50 and the second bearing inner ring 52. In one alternative design of the invention, such a seal or a plurality of such seals can be present in order to reliably prevent dirt from a spatial region 60, which is farther inboard-side in comparison to the tapered roller bearing 56, from reaching between the bearing inner ring 52 and the axle pin 50.

Furthermore, the wheel bearing assembly is free of seals that seal against a radial outer side of the first bearing inner ring and a radial outer side of the second bearing inner ring between the first bearing inner ring and the second bearing inner ring of the wheel bearing assembly. In one alternative embodiment of the invention, such a seal can be present.

The bearing inner ring 36 includes a raceway 46, on which rolling elements 48 roll during operation. The groove 44 is spaced from the raceway 46 in the axial direction of the wheel bearing assembly.

The axle pin 50 is hollow. Through it a driveshaft (not shown) extends, which is provided for driving a wheel (not shown) supported by the wheel bearing assembly. For this purpose, in a fully installed state the driveshaft is attached to the hub 35 with the aid of screw holes 62. The respective wheel is attached radially farther outward of the holes 64 of the hub 35. The driveshaft is oil-lubricated, and oil is located between the driveshaft and the axle pin 50. The oil can also lubricate a differential disposed on the driveshaft. Furthermore, a planetary transmission can be disposed outboard relative to the tapered roller bearing 54, which planetary transmission can also be lubricated by the oil.

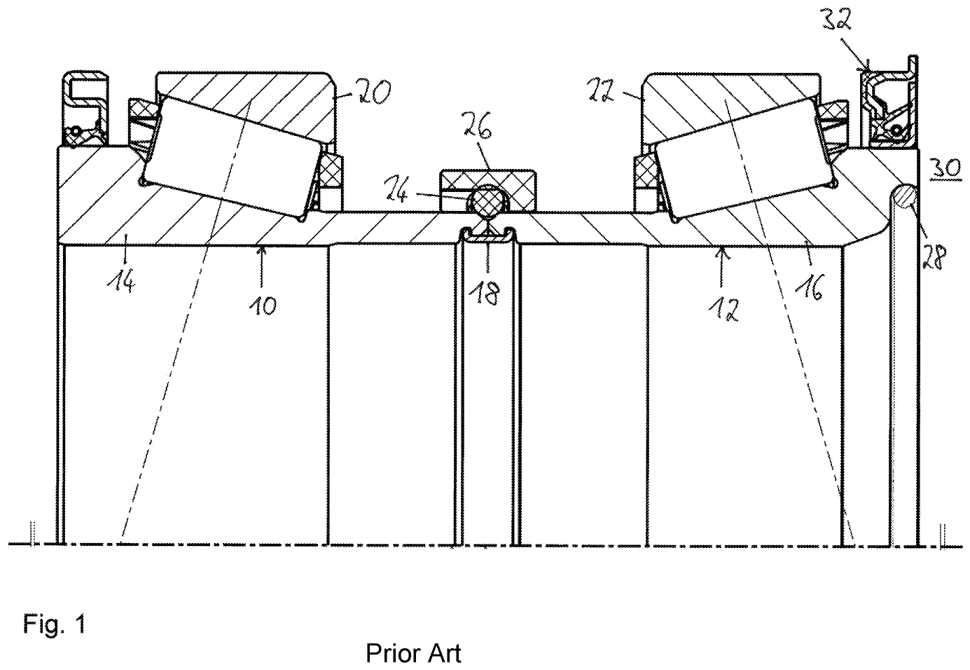

In a method for installing the wheel bearing assembly, the seal element 40 is first attached in the groove 44, and subsequently the tapered roller bearing 54 is pressed into the hub 35. Then the hub 35 is installed on the axle pin together with the tapered roller bearings 54, 56. Thus, already prior to a delivery of the tapered roller bearing 54 to a location at which it is installed on the axle pin 50, a manufacturer of the tapered roller bearing 54 can ensure by installing the seal element 40 that in a fully installed state, no oil that is provided for lubricating the driveshaft and that can be disposed in a spatial region 66 that is outboard of the tapered roller bearing 54 can move forward. In comparison to the O-ring 24 of the embodiment according to FIG. 1, the seal element 40 has the advantage in particular that an optical monitoring of a correct seat in a final installation position is significantly better able to be done. The seal element 40 also prevents oil from reaching the spatial region 66 into a region between the outer ring of the tapered roller bearing 56 and the bearing inner ring 52, and subsequently reaching into the spatial region 60, in which a brake disc is disposed, through a seal 68 facing the spatial region 60. Oil that reaches the brake disc can seriously impair a brake function of the motor vehicle. The seal element 40 is also more cost-effective than a seal including the O-ring 24 according to FIG. 1.

The tapered roller bearings 54, 56 are both lubricated by lubricating grease.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Tapered roller bearing
12 Tapered roller bearing
14 Inner ring
16 Inner ring
18 Ring
20 Outer ring
22 Outer ring
24 O-ring
26 Plastic ring
28 O-ring
30 Spatial region
32 Seal
35 Hub
36 Bearing inner ring
38 End
40 Seal element
42 Inner surface
44 Groove
46 Raceway
48 Rolling elements
50 Axle pin
52 Bearing inner ring
54 Tapered roller bearing
56 Tapered roller bearing
58 Ring
60 Spatial region
62 Screw hole
64 Hole
66 Spatial region
68 Seal

What is claimed is:

1. A wheel bearing assembly comprising:
a hub having an axial outboard end,
a first bearing installed in the hub, the first bearing having an outer ring and an inner ring, and
at least one seal element that seals against a radially inner surface of the first bearing inner ring in a liquid-tight manner,
wherein the first bearing is the outboard-most bearing of the wheel bearing assembly.

2. The wheel bearing assembly according to claim 1,
wherein the first bearing inner ring includes a groove on the radially inner surface, and
wherein the at least one seal element is at least partially mounted in the groove.

3. The wheel bearing assembly according to claim 2,
wherein the groove is axially spaced from a raceway of the first bearing inner ring.

4. The wheel assembly according to claim 2,
wherein the groove is axially spaced from rolling elements of the first bearing inner ring.

5. The wheel bearing assembly according to claim 1,
including an axle pin, and
a second bearing having an outer ring and an inner ring,
wherein the wheel bearing assembly is free of seals that are disposed between the axle pin and the second bearing inner ring.

6. The wheel bearing assembly according to claim 1,
wherein the wheel bearing assembly is free of seals that seal against a radially outer side of the first bearing inner ring between the first bearing inner ring and a second bearing inner ring.

7. The wheel bearing assembly according to claim 2,
wherein the seal element comprises an O-ring.

8. The wheel bearing assembly according to claim 1,
including an axle pin,
wherein the seal element seals between the first bearing inner ring and the axle pin in a liquid-tight manner.

9. A wheel bearing inner ring including a groove on a radially inner surface and an O-ring at least partially disposed in the groove.

10. A truck comprising:
the wheel bearing assembly according to claim 1, and
a wheel supported by the wheel bearing assembly,
wherein the wheel is configured to be driven by an oil-lubricated driveshaft of the motor vehicle.

11. The wheel bearing according to claim 1,
including sealing means for sealing between the bearing inner ring and the hub.

12. The wheel bearing according to claim 1,
wherein the first bearing outer ring is pressed into the hub.

13. The wheel bearing according to claim 12,
including a second bearing installed in the hub and having an inner ring and an outer ring,
wherein the second bearing inner ring is connected to the first bearing inner ring at a joint by a connecting ring.

14. A wheel bearing assembly comprising:
a hub having an axial outboard end,
an axial inner bearing installed in the hub and comprising an outer ring pressed into the hub and an inner ring, the inner ring having a first raceway on a radially outer surface,
an axial outboard-most bearing installed in the hub and comprising an outer ring pressed into the hub and an inner ring, the inner ring of the axial outboard-most bearing having a second raceway and a groove on a radially inner surface, the groove being located axially outward of the second raceway, and
an O-ring in the groove,
wherein the axially outboard-most bearing is located between the axially inner bearing and the axial outboard end of the hub.

15. The wheel bearing assembly according to claim 14,
including an axle pin supporting the inner ring of the axial inner bearing and the inner ring of the axial outboard-most bearing, the O-ring forming a liquid-tight seal against the axle pin.

16. The wheel bearing assembly according to claim 15,
including a seal between a radial outer surface of the inner ring of the axial outboard-most bearing and the hub.

17. The wheel bearing assembly according to claim 14,
wherein the inner ring of the axial inner bearing and the inner ring of the axial outboard-most bearing meet at a joint,
wherein a connecting ring is located at a radial inner end of the joint, and
wherein no seal element is located at the radially outer end of the joint.

18. The wheel bearing assembly according to claim 17,
wherein the radially outer surface of the inner ring of the axial inner bearing is flush with the radially outer surface of the inner ring of the axial outboard-most bearing.
